(19) United States
(12) Patent Application Publication
(10) Pub. No.: US 2012/0275175 A1
(43) Pub. Date: Nov. 1, 2012

(54) VEHICLE LAMP GENERATING SUPERIMPOSED LIGHT SPOTS

(75) Inventor: Dirk Kliebisch, Paderborn (DE)

(73) Assignee: HELLA KGAA, Lippstadt (DE)

(21) Appl. No.: 13/440,579

(22) Filed: Apr. 5, 2012

(30) Foreign Application Priority Data
Apr. 7, 2011 (DE) 102011001865.4

(51) Int. Cl. B60Q 1/14

(52) U.S. Cl. 362/538

(57) ABSTRACT

Illumination device for a dazzle-free high beam function with a plurality of LED light sources and an optical unit, with a sensor appliance to detect approaching road users and/or road users travelling in front, with a control mechanism which activates the LED light sources by means of dimming or turning them on and off depending on the sensor data supplied by the sensor assembly in such a way that an anti-dazzling area of the high beam function corresponding to the approaching road user and/or the road user travelling in front is created to prevent the road user from being dazzled, wherein at least the optical unit assigned to the high beam function includes optical elements assigned to the same LED light source, thereby producing least two light spots for every LED light source with the capability to superimpose the light spots on each other to create a combined light spot.

### RELATED APPLICATIONS

This application claims priority and benefit of German Application No. 10 2011 001 865.4, filed on Apr. 7, 2011, all of which is incorporated herein by reference.

### BACKGROUND OF THE INVENTION

1. Field of the Invention

Illumination device for the generation of a dazzle-free high beam function with a plurality of LED light sources and an optical unit to create a high beam function, with a sensor assembly to detect approaching road users and/or road users travelling in front, with a control mechanism which activates the LED light sources by means of dimming or turning them on and off depending on the sensor data supplied by the sensor assembly in such a way that an anti-dazzling area of the high beam function corresponding to the approaching road user and/or the road user travelling in front is created to prevent the road user from being dazzled.

2. Related Art

An illumination device with an LED light source and an optical unit assigned to it is disclosed in DE 10 2009 000 557 A1. The optical unit is designed as a reflector which comprises two reflective sections with different orientations toward the LED light source. A first reflective section depicts the LED light source as a first light spot and a second reflective section depicts the same as a second light spot, wherein the two light spots are arranged side-by-side in horizontal direction on the one hand and form a graduated light/dark boundary on the other hand. This way, a uniform horizontal light/dark boundary is provided for a low beam function.

An illumination device for the creation of a dazzle-free high beam function is disclosed in DE 10 2004 042 092 A1, which comprises a plurality of LED light sources. An optical unit is assigned to the LED light sources, which comprises a plurality of adjustable micromirrors each assigned to one LED light source as well as a reflector or a converging lens. The disclosed illumination device comprises a sensor assembly to detect approaching road users and/or road users traveling in front. Furthermore, the disclosed illumination device comprises a control mechanism by means of which the LED light sources are activated in such a way that a non-illuminated anti-dazzling area is formed in the traffic area depending on the actual location of the approaching road user and/or the road user traveling in front. This ensures that the road user in the traffic area is not dazzled by the illumination device. The disadvantage of the disclosed illumination device is that the mechanical effort required to adjust the micromirrors is relatively high.

An illumination device for the generation of a dazzle-free high beam function is disclosed in DE 10 2005 041 234 A1, which comprises a plurality of LED light sources. A shared first optical unit for the generation of a basic light function is assigned to a first plurality of LED light sources. A shared second optical unit for the generation of a high beam function superimposed on the basic function is assigned to a second plurality of LED light sources. Depending on sensor data concerning an approaching road user and/or a road user traveling in front detected by means of a sensor assembly, a control mechanism activates the LED light source in such a way that an anti-dazzling area corresponding to the road user within the traffic area is created in the high beam function which is illuminated to such an extent that dazzling of the road user is prevented. No angling of components is required for the creation of the dazzle-free high beam function, and the activation-related expenses are therefore reduced. However, reproduction errors in a marginal area of the light distribution arrangement are generated because of the relatively wide dimension of the optical unit designed as a lens, thus limiting the anti-dazzling effect in said marginal area.

Therefore, the object of the present invention is to upgrade an illumination device for the generation of a dazzle-free high beam function with a plurality of LED light sources and an optical unit in such a way that the provision of light distribution arrangements matching the requirements of the traffic area is improved in a simple and effective photometric fashion.

### SUMMARY OF THE INVENTION

To solve this object, the invention in connection with the preamble of patent claims 1 is characterized in that at least the optical unit assigned to the high beam function comprises a plurality of optical elements each assigned to the same LED light source, so that every LED light source is reproduced with at least two light spots, wherein on a test screen a first light spot comprises a vertical light/dark boundary on a left side and a second light spot comprises a vertical light/dark boundary on a right side, and that the optical elements are designed in such a way that the first light spot and the second light spot can be superimposed on each other to create a combined light spot, wherein the combined light spot comprises the vertical light/dark boundary of the first light spot or the second light spot, respectively on the left side and the right side.

The special advantage of the invention is that defined reproduction properties can be realized by assigning separate optical elements to a plurality of LED light sources, so that a defined anti-dazzling area can be created in a high beam distribution arrangement. The fact that a plurality of light spots with two opposed vertical light/dark boundaries can be reproduced on a test screen makes it possible to set an anti-dazzling area with different widths by activating individual or a plurality of LED light sources. Depending on the actual position of the road user within the traffic area in front of the illumination device, it is therefore possible to achieve an improved anti-dazzling effect. The basic idea of the invention is to depict an extensive LED light source with two vertical sharp light/dark boundaries, so that certain anti-dazzling areas depending on the traffic situation can be activated in the high beam distribution arrangement and hence an approaching road user cannot be dazzled. The depiction of the LED light sources with two relatively sharp vertical light/dark boundaries each allows the generation of a plurality of switchable anti-dazzling areas.

According to a preferred embodiment of the invention, the right side of the first light spot and the left side of the second light spot have a non-vertical light-dark boundary or a fuzzy light/dark boundary, respectively, so that a combined light spot can be created by superimposing the two light spots which has relatively sharp light/dark boundaries on the right and left side. This can ensure a dazzle-free high beam function, specifically by means of rigid, immobile photometric components, wherein different anti-dazzling areas of the high beam distribution arrangement can be created by turning the LED light sources on and/or off.

According to an upgrade of the invention, the optical elements are each designed as reflector sections, wherein two reflector sections of a reflector with different orientations are preferably assigned to one LED light source. Advantageously, the reflector sections can be oriented in such a way that in each case they only need to depict a single sharp vertical light/dark boundary.

According to an upgrade of the invention, a plurality of LED light sources is combined to an LED lamp field (array), so that a homogeneous light distribution arrangement is generated when all LED light sources of the same LED lamp field are turned on.

According to a preferred embodiment of the invention, the optical element is designed or assigned to the LED light source in such a way that a rectangular or square light spot is depicted on a test screen when the LED light source is activated. As a result, the high beam distribution arrangement is composed of a plurality of said rectangular or square light spots, wherein corresponding vertical light/dark boundaries are depicted through the vertical edges of the light spots, by means of which anti-dazzling areas with a constant or variable width (in horizontal direction) can be created. Consequently, the anti-dazzling area can be set variably depending on the object within the traffic area to be anti-dazzled.

According to an upgrade of the invention, the combined light spots for the generation of the high beam distribution arrangement are arranged side-by-side in horizontal direction. Because the high beam distribution arrangement is created with a plurality of combined light spots, which comprise a sharp light/dark boundary each on the left and right side, the anti-dazzling area has a relatively high illuminance gradient both on the right as well as the left side.

Further advantages of the invention can be gathered from the other claims.

Further areas of applicability of the present invention will become apparent from the detailed description provided hereinafter. It should be understood that the detailed description and specific examples, while indicating the preferred embodiment of the invention, are intended for purposes of illustration only and are not intended to limit scope of the invention.

### BRIEF DESCRIPTION OF THE DRAWINGS

One exemplary embodiment of the invention is explained in more detail below by means of drawings.

FIG. 1 shows a perspective front view of a segment of the illumination device, which is formed with an LED lamp field and a reflector assigned to the same,

FIG. 2a shows a depiction of the LED light source on a test screen which is exclusively generated by way of reflection of the first reflector section of the reflector (first light spot),

FIG. 2b shows a depiction of an LED light source on a test screen which is exclusively generated by way of reflection of a second reflector section of the reflector (second light spot),

FIG. 2c shows a depiction of the LED light source on a test screen which is exclusively generated by way of reflection of the reflector (combined light spot),

FIG. 3 shows a depiction of the LED light sources combined to an LED lamp field on a test screen, and

FIG. 4 shows a representation of the high beam distribution arrangement with the superimposition of a plurality of LED light sources and reflectors assigned to them, wherein an anti-dazzling area is created by turning off an LED lamp field in which no light is depicted.

### DETAILED DESCRIPTION OF THE PREFERRED EMBODIMENT

An illumination device according to the invention is used as headlights to generate a dazzle-free high beam function in a motor vehicle. The purpose of said headlights is to be able to generate a dynamic light function (Advanced Front lighting System, AFS), which allows the driving condition-related illumination of the road or the traffic area. For this purpose, LED light sources 1 of the headlights are turned on or off or dimmed (their brightness varied) by means of a control mechanism which is not illustrated. The control mechanism is connected with a sensor assembly on the input side which is designed to detect approaching road users and/or road users (objects) traveling in front. Depending on the sensor data provided by the sensor assembly, the LED light sources 1 of the illumination device are activated by a control mechanism, i.e. turned on or off or dimmed.

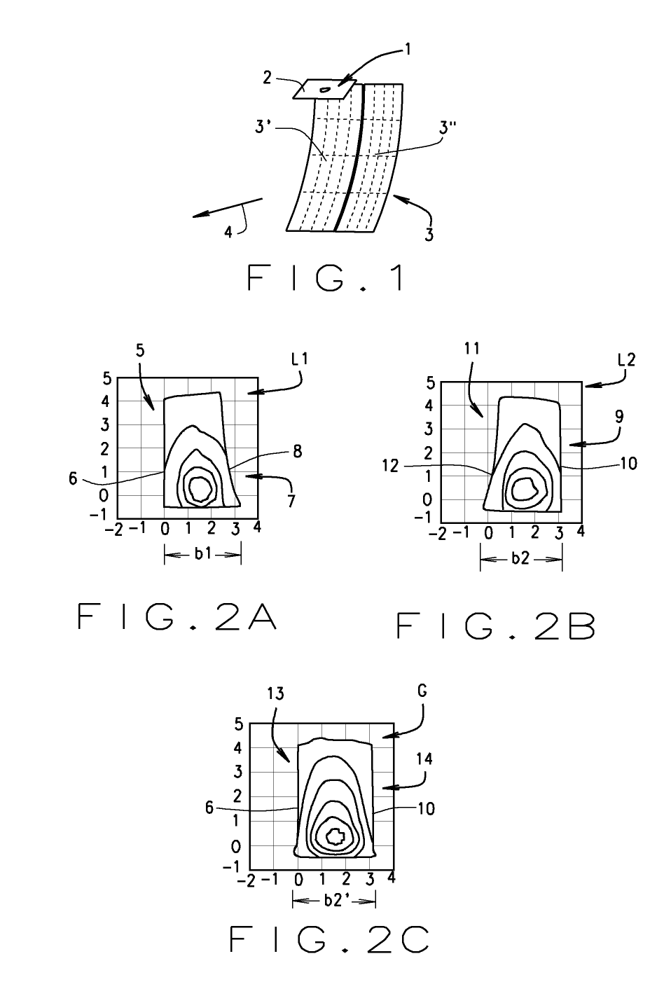

In the present exemplary embodiment, the LED light sources 1 designed as LED chips are combined to an LED lamp field 2 (LED array), so that a higher illuminance is realizable with respect to a relatively small area. To create the desired light distribution, a plurality of LED lamp fields 2 is arranged in rows, for example in horizontal direction. An optical unit is assigned to the LED light sources 1 or the LED lamp fields 2, which consists of a plurality of optical elements. The optical elements are each designed as reflectors 3, which are each assigned to an LED light source 1 or an LED lamp field 2. FIG. 1 illustrates an example of a segment of the illumination device which is formed by the LED lamp field 2 and the reflector 3. The entire illumination device consists of a plurality of such segments, which can be arranged for example in a straight line and/or in arc-shaped fashion.

The reflectors 3 are arranged in the main direction of the beam 4 behind the LED light sources 1 or the LED lamp fields 2. An optical axis of the LED light sources 1 forms an acute angle with the main direction of the beam 4. The LED light sources 1 are arranged at a slope to a horizontal plane in order for the light emitted by the LED light sources 1 to be deflected to the back and then on the respective reflectors 3 to the front in the main direction of the beam.

The reflector 3 comprises a first reflector section 3′ by means of which the LED light source 1 is depicted as a first light spot L1 illustrated in FIG. 2a. Furthermore, the reflector 3 comprises a second reflector section 3″ by means of which the LED light source 1 is reflected as a second light spot L2 illustrated in FIG. 2b. The first reflector section 3′ and the second reflector section 3″ can each comprise a horizontal and/or vertical subdivision. The first reflector section 3′ is designed in such a way that the first light spot L1 has a vertical light/dark boundary 6 on a left side 5 and has no vertical light/dark boundary, but instead an arc-shaped light/dark boundary 8 on a right side 7.

The second reflector section 3″ is designed in such a way that the second light spot L2 has a vertical light/dark boundary 10 on a right side 9 and has no vertical light/dark boundary, but instead an arc-shaped light/dark boundary 12 on a left side 11.

The LED light source 1 is depicted as a combined light spot G illustrated in FIG. 2c by means of the reflector 3 with the superimposition of the first light spot L1 and the second light spot L2, said combined light spot having the vertical light/dark boundary 6 of the first light spot L1 on a left side 13 and the vertical light/dark boundary 10 of the second light spot L2 on a right side 14.

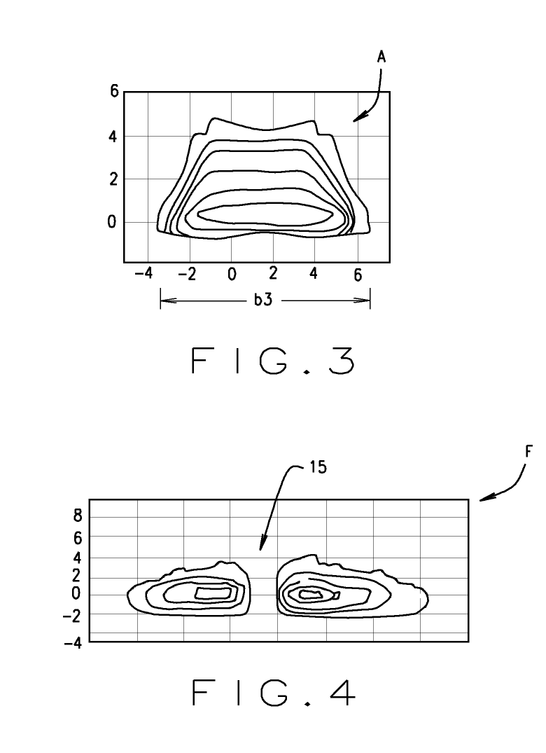

In FIGS. 2a to 3, the light spots L1, L2, G are depicted on a test screen set up at a distance of 20 meters.

The spreads of the first reflector section 3′ and the second reflector section 3″ are adjusted in such a way that a width b1 of the first light spot L1 and the second light spot L2 or the position of the light spots L1 and L2 can be set. In particular, the spread of the reflector sections 3′, 3″ is adjusted in such a way that the vertical light/dark boundary 6, 10 of the light spot L2, L1 generated by the other reflector section is not crossed.

If all LED light sources 1 of the LED lamp field 2 are turned on, a light distribution A illustrated in FIG. 3 is created. The combined light spot G has a width b2′ which essentially corresponds to the widths b1 and b2 of the light spots L1 and L2, and can be designed slightly larger than the widths b1, b2 if necessary, if the light spots L1, L2 are not completely overlapping. It can be seen that a width b3 of the lamp field light distribution arrangement A is greater than the widths b1, b2 and b2′ of the light spots L1, L2, G.

A high beam distribution arrangement F according to FIG. 4 can be created by turning on a plurality of illumination segments illustrated in FIG. 1, wherein in the present case said high beam distribution arrangement F comprises an anti-dazzling area 15 in which no light is depicted. To generate said anti-dazzling area 15, the LED light source 1 of the LED lamp field 2 provided for this area of the light distribution arrangement F is in switched-on state, so that a road user present in the anti-dazzling area 15 is not dazzled.

The LED light sources 1 of the illumination device are activated in such a way that a homogeneous high beam function is created. Depending on the sensor data detecting the location of other road users, the LED light sources 1 are activated selectively, in order to create the high beam distribution arrangement F with locally changing anti-dazzling areas 15. Rather than creating the anti-dazzling area 15 by turning off the corresponding LED light sources 1, they can also be dimmed to the point where an illuminance is achieved within the anti-dazzling area which is not dazzling the other road users.

To ensure that a reliable anti-dazzling is possible in particular in a marginal area, preferably in a right and/or left marginal area of the light distribution arrangement F, the reflectors 3 or the LED lamp fields 2 are arranged distributed in horizontal direction.

In order to achieve a homogeneous light distribution in horizontal direction, the reflectors 3 can also be arranged in such a way that the combined light spots G overlap in horizontal direction, which means that the vertical light/dark boundaries 6, 10 of adjacent combined light spots G extend into the marginal area of the analogous adjacent combined light spot G. In the present exemplary embodiment, the light spots L1, L2, G have a rectangular outline. Alternatively, the same can also be designed as a square. What matters is that they have a defined width b1, b2, b3, so that a plurality of locally different or different widths of the anti-dazzling areas 15 can be realized by way of dimming or turning off corresponding LED light sources 1.

According to an alternative embodiment of the invention, the optical elements can be designed as lenses rather than as reflectors 3, wherein the LED light sources 1 are preferably arranged in the main direction of the beam 4 behind said lenses.

The LED light sources 1 selected to illuminate an object in the traffic area detected by the sensor signal can be activated in such a way that the object is illuminated with changing illuminance in order to recognize the object as an obstacle.

According to an alternative embodiment of the invention, the LED light sources 1 can also be activated in such a way that blinking areas are created which indicate the presence of an object within the traffic area; said object is supposed to be recognized as an obstacle by the driver. In this case, the corresponding object is illuminated with changing illuminance, for example periodically, such that said blinking attracts the driver's attention to said object. The blinking can take place partially in an area of the light distribution arrangement F, in which the object to be perceived as an obstacle is located. Alternatively, it is also possible that the entire light distribution arrangement or a part of the light distribution arrangement blinks on and off, which makes sense in particular if the obstacle is relatively small or far away.

According to an alternative embodiment, the object to be recognized as an obstacle can also be illuminated by adding on LED light sources, so that the object is illuminated with greater illuminance than adjacent areas of the light distribution arrangement F. This is another way of attracting the driver's attention to the obstacle.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1-10. (canceled)

11. An illumination device for the generation of a dazzle-free high beam function with a plurality of LED light sources and an optical unit to create a high beam function, with a sensor assembly to detect approaching road users and/or road users travelling in front, with a control mechanism which activates the LED light sources by dimming or turning them on and off depending on the sensor data supplied by the sensor assembly in such a way that an anti-dazzling area of the high beam function corresponding to other road users is created to prevent the road user from being dazzled, comprising:
an optical unit assigned to the high beam function comprising a plurality of optical elements each assigned to the same LED light source, such that every LED light source is reproduced with at least two light spots;
said optical unit forming a first light spot on a test screen comprising a vertical light/dark boundary on a left side and a second light spot comprising a vertical light/dark boundary on a right side;
said optical elements forming said first light spot and said second light spot to be superimposable on each other to create a combined light spot, wherein the combined light spot comprises at least one of the vertical light/dark boundary of the first light spot and the second light spot, respectively on the left side and the right side.

12. The illumination device according to claim 1, characterized in that the right side of the first light spot and the left side of the second light spot comprise a non-vertical light/dark boundary.

13. The illumination device according to claim 1, characterized in that the vertical light/dark boundary of the combined light spot on the left side is formed by the vertical light/dark boundary of the first light spot and on the right side by the vertical light/dark boundary of the second light spot.

14. The illumination device according to claim 1, characterized in that the optical elements are each designed as reflective sections, wherein the first light spot can be formed through a first reflective section and the second light spot through a second reflective section.

15. The illumination device according to claim 1, characterized in that the first reflective section and the second reflective section are arranged side-by-side in horizontal direction and form a reflector, wherein a main axis of the reflector is arranged at an acute angle to an optical axis of the LED light source.

16. The illumination device according to claim 1, characterized in that the first light spot and/or the second light spot depicted on the test screen has a rectangular or square contour.

17. The illumination device according to claim 1, characterized in that a plurality of LED light sources are combined in a common LED lamp field, which comprises a width in horizontal direction that is greater than a width of the combined light spot.

18. The illumination device according to claim 1, characterized in that the LED light sources which are selected to illuminate an object in the traffic area captured by a sensor signal can be activated in such a way that the object is illuminated with varying illumnance in order to detect the object as an obstacle.

19. The illumination device according to claim 1, characterized in that the LED light sources which are selected to illuminate an object in the traffic area captured by the sensor signal can be activated in such a way that the object is illuminated with an increased illuminance compared to neighboring areas of the light distribution arrangement in order to detect the object as an obstacle.

20. The illumination device according to claim 1, characterized in that the combined light spots are arranged side-by-side in horizontal direction in order to create the high beam distribution arrangement, wherein an extension direction of the row of combined light spots runs perpendicular to the vertical light/dark boundary of the light spots.
